(19) United States
(12) Patent Application Publication
(10) Pub. No.: US 2010/0003645 A1
(43) Pub. Date: Jan. 7, 2010

(54) EDUCATION METHOD AND TOOL

(75) Inventor: William M. Hathaway, Powell, OH (US)

Correspondence Address: MICHAEL BEST & FRIEDRICH LLP, 100 E WISCONSIN AVENUE, Suite 3300, MILWAUKEE, WI, 53202, US

(73) Assignee: MORESTEAM.COM LLC, Lewis Center, OH (US)

(21) Appl. No.: 12/166,967

(22) Filed: Jul. 2, 2008

(51) Int. Cl. G09B 19/00

(52) U.S. Cl. 434/107

(57) ABSTRACT

A method of, and tool for, enhancing a student's knowledge and skill in Six Sigma concepts. The tool is computer-based and enhances and evaluates a student's knowledge of and skill in the DMAIC process of Six Sigma. The tool allows the student to apply his newly-obtained knowledge of Six Sigma methodologies to a simulated real-world situation.

### BACKGROUND

Six Sigma has become a popular name used to identify a methodology for improving and maintaining processes to achieve business success. “Six Sigma” commonly refers to an initiative that uses the Define-Measure-Analyze-Improve-Control (DMAIC) roadmap to identify, initiate, and complete a series of projects targeting processes that are not operating satisfactorily.

All kinds of organizations, from manufacturers, service providers, non-profit organizations, government agencies, to even schools, have found success applying Six Sigma to their enterprise. The gains Six Sigma can help achieve include increased profitability (either by reduced costs or enhanced revenue), improved social service outcomes or worker safety, and improved environmental impact, to name a few.

Each phase of DMAIC entails a variety of activities leading to an improved process. A common link among them is data—using data to make decisions, to understand customer requirements, and to assure that processes are meeting those requirements.

In another, more technical sense, the term “Six Sigma” refers to a statistical performance measure. Sigma is a Greek letter (σ) used to represent variance. A metric called Sigma Level allows comparative measurement of different processes used to produce products and services. A Sigma Level of six indicates a very high level of defect-free operation of a process (only 3 defects per each million opportunities). “Six Sigma” is used both in its technical sense to describe a process' capability and in its descriptive sense as a performance goal.

Though not all problems are necessarily good Six Sigma project candidates, adopting DMAIC as an organized, data-driven approach to problem identification and resolution can improve the bottom line dramatically. It is estimated that an enterprise or process operating at a Sigma Level of 2 wastes about 30% of every dollar of revenue. Eliminating costly defects in products and services can knock down that percentage significantly, and at the same time improve customer satisfaction and sales.

The principles of DMAIC can be applied in virtually any working environment. Understanding the customer, focusing on customers' requirements, gathering data, and challenging decisions made without supporting data, all become second nature in organizations utilizing the Six Sigma methodology. The ability to practice a new skill set is a key to developing and applying the skill set under real-world circumstances, including skills in applying DMAIC principles.

The five phases of DMAIC are Define, Measure, Analyze, Improve, and Control.

Define is the initial phase of the DMAIC framework. The activities in the Define phase include identifying and prioritizing potential projects based on anticipated impact and alignment with the organization's strategic imperatives and operating plans. Six Sigma projects start by understanding the customer (maybe even identifying who the customer is) and understanding the process under study.

Measure—a primary objective of the Measure phase is to establish data reflecting the state of the process that is the subject of the project. Compiling a complete and accurate picture of a process at the beginning of a project allows the process owners to better understand whether or not improvements are eventually realized. Also, because the DMAIC roadmap is a closed loop approach to problem solving, the Measure phase of projects also includes gathering data about the improved process to assure it is stable and sufficiently capable to consistently meet the customer's requirements.

The Analyze phase of DMAIC occurs after identifying the process and gathering key metric data. In the Analyze phase of process improvement, important objectives include understanding the root causes of undesirable variation and the causal relationships of various inputs to the output of the studied process. Among the tools used in the Analyze phase are well-known graphical and statistical tools such as cause & effect diagrams, scatter plots, regression analysis, hypothesis testing, and design of experiments.

The Improve phase of the DMAIC framework brings possible solutions to bear on the root causes identified in Analyze. Continued measurement of key metrics develops data from which degrees of improvement can be identified, i.e., the proposed solutions can be validated. Other considerations during the Improve phase include evaluation of alternative solutions, development of plans to pilot changes, and determination of costs associated with the proposed solutions.

The object of the Control phase is to assure that the problems addressed by the project are permanently resolved. Basic to achieving that objective is establishing and validating a process monitoring system. Other tasks of an administrative nature fall into this phase as well: calculation/documentation of cost savings or improvement of other key metrics, documenting procedures, and sharing of lessons learned.

### SUMMARY

The present invention relates to a method of, and tool for, enhancing and evaluating a student's knowledge and skill in a subject. Specifically, the invention relates to a computer-based tool (e.g., a simulated project game) for evaluating a student's knowledge of and skill in the DMAIC process of Six Sigma. The tool allows the student to practice and apply his newly-obtained knowledge of Six Sigma methodologies to a simulated real-world situation.

In one embodiment, the invention provides a method of enhancing a student's knowledge of Six Sigma quality concepts. The method comprises the acts of establishing a scenario; providing a plurality of phases in the scenario, the phases related to the Six Sigma quality concepts; providing a plurality of tasks for each of the plurality of phases, the plurality of tasks based on the scenario and the plurality of phases; assigning a cost to each of the plurality of tasks; enabling the student to choose and execute one or more of the plurality of tasks for each phase; charging the student the cost for each of the plurality of tasks executed; providing the student with a plurality of questions, the questions formulated to test the student's understanding of the scenario, the student's understanding being enhanced by the executed tasks; and scoring the student's answers to the plurality of questions and the costs charged.

In another embodiment the invention provides a simulation tool for enhancing a user's comprehension of a Six Sigma lesson. The tool comprises a computer processor including a browser application; a database accessible by the computer processor; and a software program stored in a computer readable medium accessible by the computer processor. The software program is operable to present a webpage configured to be accessed by the browser application, retrieve content from the database, and deliver the content to the webpage, the content configured to evaluate the user's comprehension of the Six Sigma lesson.

In yet another embodiment, the invention provides a method of enhancing a user's knowledge of the Six Sigma DMAIC process. The method comprises displaying a plurality of phases to the user, the phases including a define phase, a measure phase, an analyze phase, an improve phase, and a control phase, the plurality of phases being provided in a predetermined order; preventing a user from accessing one of the plurality of phases until a previous one of the plurality of phases has been completed; displaying an introduction, a plurality of tasks, and an evaluation for each of the plurality of phases; generating a review for each of the plurality of phases after a respective one of the plurality of phases is completed; penalizing the user for executing one of the plurality of tasks for a respective one of the plurality of phases after the evaluation for the one of the plurality of phases has been started; and generating an indication of expertise of the user based on the plurality of tasks executed and a result of the evaluations for each of the plurality of phases.

Other aspects of the invention will become apparent by consideration of the detailed description and accompanying drawings.

### BRIEF DESCRIPTION OF THE DRAWINGS

FIG. 1 is a schematic diagram of a system adapted to practice a method of the invention.

FIG. 2 is a schematic diagram of a system adapted to practice a method of the invention.

FIG. 3 is an illustration of an exemplary webpage of an embodiment of the invention.

FIG. 4 is an illustration of an exemplary introductory webpage of an embodiment of the invention.

FIG. 5 is an illustration of an exemplary introductory webpage of an embodiment of the invention.

FIG. 6 is an illustration of an exemplary introductory webpage of an embodiment of the invention.

FIG. 7 is an illustration of an exemplary introductory webpage of an embodiment of the invention.

FIG. 8 is an illustration of an exemplary introductory webpage of an embodiment of the invention.

FIG. 9 is an illustration of an exemplary webpage of an introduction to an embodiment of a simulation of the invention.

FIG. 10 is an illustration of an exemplary task webpage of an embodiment of the invention.

FIG. 11 is an illustration of an exemplary tollgate entry verification webpage of an embodiment of the invention.

FIG. 12 is an illustration of an exemplary scorecard webpage of an embodiment of the invention.

FIGS. 13A-13E are flow charts of an embodiment of a method of the invention.

FIG. 14 is an illustration of an exemplary review webpage of an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. The terms connected and coupled and variations thereof herein are not restricted to physical and mechanical connections or couplings.

As used herein the term “computer” is not limited to a device with a single processor, but may encompass multiple computers linked in a system, computers with multiple processors, special purpose devices, computers or special purpose devices with various peripherals and input and output devices, software acting as a computer or server, and combinations of the above. In general, computers accept and process information or data according to instructions (i.e., computer instructions).

The five-step DMAIC process is summarized by the following description of the phases. The DMAIC framework does not necessarily involve a strictly linear process—it often requires an iterative approach to problem solving. New information and discovery may cause a return to previous steps and redefinition of the project or modification of the approach to completing the project. There are numerous other problem solving approaches that incorporate frameworks differing from DMAIC to varying degrees. For example, there are multiple approaches to process improvement that include and/or omit elements of the DMAIC framework, or that recast various DMAIC steps in other terms. Those of ordinary skill in the art will recognize that the methods and tools described herein can incorporates application of the methods and tools to providing a facility for practicing and applying a wide variety of problem solving methods.

Each phase can be partially defined by considering one or more critical questions that are answered as the problem solving methodology progresses.

The Define phase prioritizes projects based on business impact and alignment with business plan. Six Sigma projects start by capturing the voice of the customer: (a) identifying what the customer wants, (b) organizing a team to improve a process, and (c) creating a process map of the process. The process map can be in one of many formats and includes suppliers, inputs, the process, outputs, customers (e.g., an SIPOC chart), and, for projects with a “lean” emphasis, a value stream map.

There are several critical questions that should be answered during the Define phase. (1) What is the goal (what is the mission)? (2) What is the project scope? Is the project scope broad enough to be important (significant to the business), but narrow enough to be do-able? (3) Why is this project being undertaken? What is the business case for this activity? (4) Who is the customer? (5) What output (Y) is important to the customer? What are the Critical-To-Quality Characteristics? (6) How does the current process flow? What are the current inputs (X) to the process? (7) What resources are required to complete the project? Who is going to work on the project? (8) When must the project be completed?

The Measure phase drives the Six Sigma process—what gets measured gets done. The Measure phase incorporates (a) selecting measurable CTQC's (Critical to Quality Characteristics), (b) defining performance standards, (c) validating a measurement system, (d) establishing baseline performance in terms of Sigma Capability—based on defects per million opportunities.

As with the Define phase, there are several critical questions that should be answered during the Measure phase. (1) What is the operational definition for all Critical-To-Quality Characteristics (CTQCs)? (2) Can the CTQCs be objectively measured? (3) Is the measurement system capable of providing valid and reliable values with an acceptable degree of error? (4) What is the baseline performance of the process? (5) Has a success target been determined—in customer terms? (6) Are the relevant metrics visible and widely accessible?

In the Analyze phase, analytical tools are used to dissect the root cause of process variability and separate the vital few inputs from the trivial many. The Analyze phase incorporates (a) identifying significant characteristics (inputs, or Xs) and establishing process capability, (b) defining performance targets for the significant characteristics (inputs, or Xs), (c) identifying the root cause of process variation, and (d) using statistical methods to verify the effectiveness of alternatives.

As with the previous phases, there are several critical questions that should be answered during the Analyze phase. (1) What are the significant inputs (Xs) affecting the output of concern (also known as Ys or CTQCs)? (2) What are the target levels of those inputs (Xs) that optimize the output of concern? (3) Are the input processes stable and capable? (4) What are the underlying sources of process variability? (5) Have alternate methods been statistically validated as effective? (6) Are the interactions between inputs identified, understood, and optimized?

The Improve phase turns the analysis into action by (a) identifying and evaluating potential solutions, (b) implementing short term countermeasures, (c) implementing long term corrective actions, (d) identifying systemic indirect effects and unintended consequences of improvements, and (e) establishing operating tolerances for new processes.

The Improve phase critical questions include (1) What improvement actions are necessary to achieve targeted performance levels? (2) Has a process been established to track implementation—with defined responsibility and target dates? (3) Does information and material flow smoothly through the process, with low inventory and no delays? (4) Are there any obstacles to improvement? Unintended consequences? Indirect effects? (5) How might the system push back? (6) Is the Six Sigma team functioning as effectively as possible? (7) Have improvement action alternatives been evaluated for relative attractiveness?

After implementing the improvement actions, the Control phase verifies results and consolidates the gains. The Control phase incorporates (a) verifying corrective actions and validating new measurement systems, (b) determining new process capability, (c) establishing and implementing a control plan, and (d) sharing best practices and lessons learned.

The Control phase critical questions include: (1) Have mechanisms been put in place to provide ongoing feedback and prevent backsliding? (2) Are significant characteristics (inputs and process variables) being monitored and improved over time using statistical methods? (3) Are appropriate preventive actions in place, including a Total Productive Maintenance (TPM) program to attack waste? (4) Are improvements, lessons learned, and best practices being shared in a systematic fashion?

The present invention is a computer-based tool that enables a student to practice knowledge of and skills learned in Lean Six Sigma methodologies, specifically DMAIC, by providing a simulation which presents a scenario where the student determines which of a series of tasks to perform for each phase of the DMAIC process. The computer-based tool can evaluate how well the student has done in each phase by providing a series of questions based on the critical questions discussed above. The computer-based tool gauges the student's skill in and knowledge of the DMAIC process based on the student's answers to the series of critical questions, also taking into account which tasks the student performed.

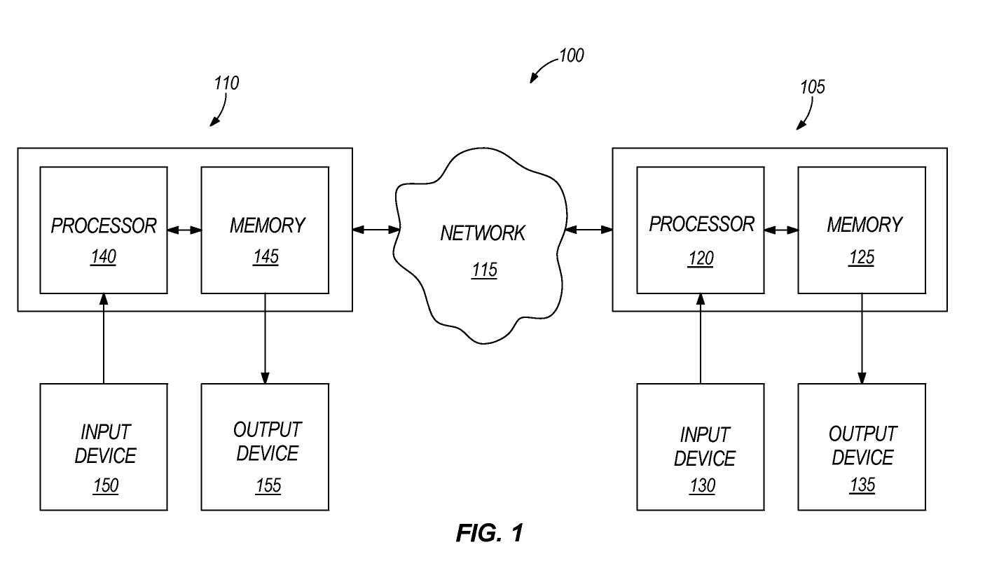

FIG. 1 schematically illustrates an exemplary system 100 for practicing the invention. In general, the system 100 includes a first computer 105 (referred to below as the client computer, client, or local computer) in communication with a second computer 110 (referred to below as the server computer, server, or remote computer) over a network 115. As explained in greater detail below, the system 100 can be used to deliver content to a user of the system 100 (e.g., instructional content). As described below, the requirements of the system 100 are flexible.

In particular, while only one client 105 and only one server 110 are shown in FIG. 1, the system 100 can include multiple servers 110 and/or multiple clients, 105 the number of clients 105 being limited only by the capacity of the network 115 and the servers 110. The client 105 includes a processor 120, memory 125 (e.g., RAM, program storage, data storage, etc.), and one or more input/output devices 130 and 135 (e.g., disk drive, optical drive, display, printer, touch screen, keyboard, mouse etc.). Example types of client computers include, but are not limited to, an electronic device capable of accessing the Internet including the World Wide Web (e.g., an Internet appliance), a handheld device, a laptop computer, a desktop computer, etc. Those of ordinary skill in the art will recognize that the terms “processor,” “client computer,” “browser,” “network” and the like are broadly defined and can apply to a wide variety of devices. The client 105 typically includes an operating system adapted to support a graphical user interface (GUI) and adapted to run a browser. The browser may be a web browser such as Netscape Navigator, Microsoft Explorer, Mozilla Firefox or a program with similar functionality that may access information from the server 110. The client 105 receives input from the input device 130 (e.g., a keyboard, a mouse, a CD-ROM, etc.) and communicates outputs to output device 135 (e.g., a display, a printer, a read/write device, etc.). Of course, the input/output devices can include a device that communicates inputs and receives outputs (e.g., a touch screen, a read/write device, etc.) The client 105 also receives inputs and communicates outputs through one or more auxiliary ports, such as a USB (universal serial bus) port, a network interface, a wireless port, and/or an embedded web interface.

The client 105 is connected to the network 115, which can be any suitable local network (LAN) or wide-area network. The server 110 can include a processor 140, memory 145, one or more input/output devices 150 and 155, and one or more auxiliary ports. The server 110 includes a server interface, such as a common gateway interface (CGI) or Internet Server Application Programming Interface (ISAPI), and a web site. The web site includes a graphical user interface module, a knowledge base, HTML, XML, and/or other files, and associated components.

Files stored in the memory 125 or input devices 130 of the client computer 105 are said to be stored locally. Files stored in the memory 145 or input devices 150 of the server 110 are said to be stored remotely.

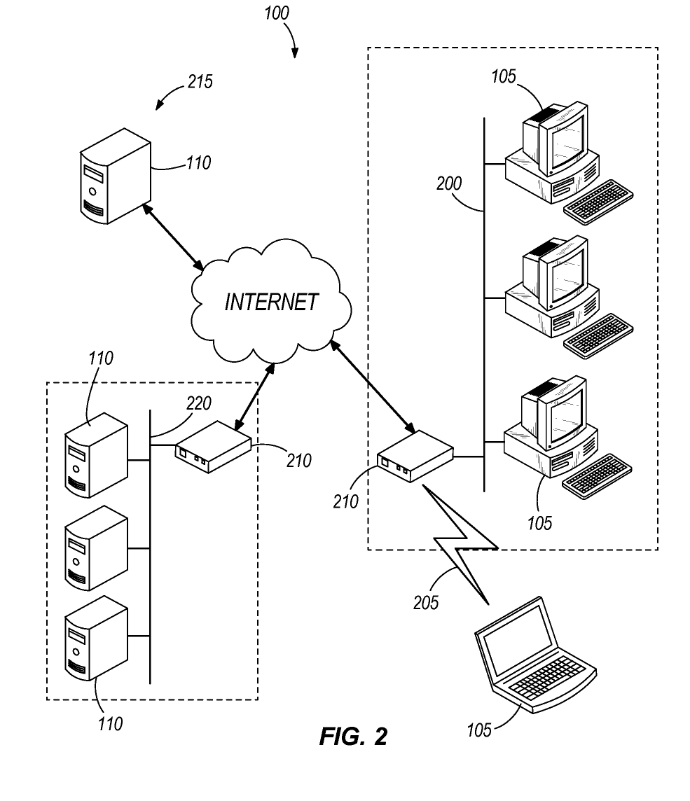

A second construction of the system 100 is shown in FIG. 2. A plurality of clients 105 reside on a LAN 200. Additional clients 105 can access the LAN 200 via a wireless interface 205. The LAN 200 includes a modem 210 for accessing the Internet. The LAN 200 can also include an intranet. The clients 105 access the Internet or intranet using Internet protocols. The clients 105 are adapted to communicate with the server 110 using Internet protocols such as TCP/IP (Transmission Control Protocol/Internet Protocol). The servers 110 can be standalone servers 215 or can reside on a LAN 220.

The operation of the invention will be described in connection with the system 100 illustrated in FIG. 1. There are, however, other systems capable of performing the invention (e.g., the system of FIG. 2). For example and as will be discussed below, not all of the components illustrated in FIG. 1 are required for some operations of the invention. In particular, the system 100 illustrated in FIG. 1 communicates content to the user of the system 100 via the network 115 and at least two computers 105 and 110. In other constructions, the content can be delivered to the user by other means. In still other constructions, the content can reside on the local computer operated by the user. For example, the content can be in the computer's local memory or on a media accessed locally by the client 105 rather than via the network 115. In some instances it is desirable to maintain the content on a server 110 to provide better security (e.g., to prevent copying and piracy).

In use of the system 100, the client 105 accesses the server 110 using a browser. The client 105 may communicate with the server 110 using known transmission standards. Once a connection is made with the server 110, the client 105 receives content from server 110. In one construction, the content includes a web page having text and links to other web pages or files (also collectively referred to as content objects). Example files include text files, executable files, audio files, video files, and audio/video files. The server 110 can also include animation objects, e.g., files that, when executed, display motion. Animation objects can be created using any suitable method (e.g., Adobe Flash, Shockwave, etc.). The server 110 includes a database comprising the content objects and the animation objects. As used herein, “display” of information of a content object is meant to include display of text files, execution of executable files, playing of audio and/or visual files, or any other method of presenting a content object to a user.

In one example, the client 105 can access a web site that, among other things, includes instructional content organized in one or more lessons. The lessons can be grouped in chapters, sections, and/or courses. Instructional content can be provided by a variety of means, including for example text files, executable files, audio files, video files, and audio/video files.

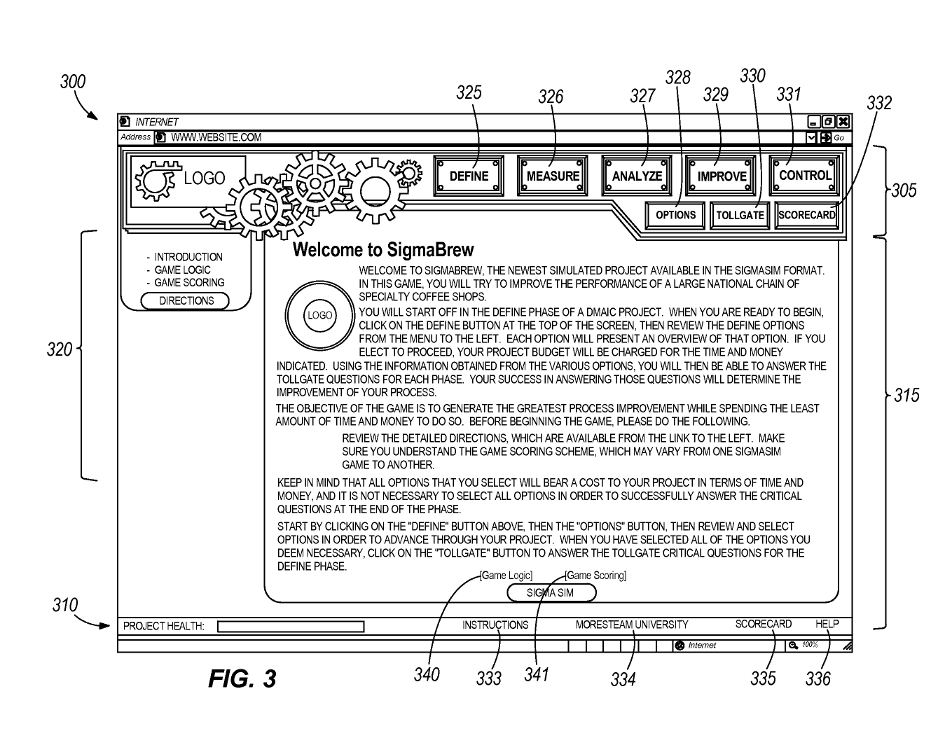

FIG. 3 is an exemplary webpage 300 of an embodiment of the invention. The webpage 300 can be created using any standard method (e.g., HTML, Java, etc.) or combination of methods. Using a browser, a client 105 accesses the webpage 300 on a server 110. The server 110 containing the webpage 300, downloads the webpage 300 to the client 105. In the embodiment shown, the webpage 300 is constructed in four sections, a main navigation section 305, a secondary navigation section 310, a first content section 315, and a second content section 320. The sections can be populated/controlled individually and can be static or dynamic. That is, the webpage 300 can, in response to an input from a user, request information (a content object) from the server 110 for display in the first content section 315, leaving the remaining sections of the webpage 300 unchanged. Thus, the content sections are dynamic (changing) and the navigation sections are static (unchanging).

The webpage 300 can include several buttons 325-336 and hyperlinks 340-341 for accessing content objects. Clicking on one of the buttons 325-336 or hyperlinks 340-341 causes the client 105 to take action such as retrieving a new content object from the server 110 and/or executing an animation object.

Display of a new content object can be subject to propagation delays, e.g., it may take several seconds (or longer) from the time a user makes a selection on the webpage 300 until the client 105 receives the new content object from the server 110 and displays the information in the content object. When a user makes a selection on a webpage by positioning a cursor over a button or hyperlink and clicking a mouse button, it is common practice for the cursor to change to a different shape (e.g., from an arrow to an hourglass) to indicate that the selection was recognized, and the new content object is being requested. The length of the delay from clicking a button, until new information is displayed, is dictated by several elements including the size of the content object (e.g., a video object may be relatively large and take a relatively long time to load where a text object may be relatively small and take a relatively short time to load), the performance (e.g., speed) of the client 105, the performance of the server 110, the number of devices accessing the server 110, and the speed of communication between the client 105 and the server 110.

It is desirable to provide a user with a consistent transition of information displays (e.g., when providing educational content) regardless of any delays. In addition, users occasionally miss the change of shape of the cursor and click more often than necessary, sometimes creating undesirable results. It is therefore also desirable to provide a more significant indication that the input has been recognized and is being operated on.

Co-pending U.S. patent application Ser. No. 12/166,905, filed Jul. 2, 2008, the entire contents of which are hereby incorporated by reference, discloses a method of transitioning between displays that provides a consistent transition regardless of delays.

The user of the system 100 can also use the client 105 to access and receive a simulation that serves as a tool, and supports the teachings of an educational lesson(s) or course(s). The simulation can have entertainment value independent of its use as an instructional tool, while also being useful as an evaluation tool. Generally speaking, one use of a model is to describe a process or series of inter-related processes. A model, or simulation, can be useful in any of a variety of ways. For example, a simulation can be used to vary (either slow or accelerate) the process from real-time. Also, a modeled process can be used to experiment with changes in the process, thus avoiding disruption in the real-time process and avoiding the costs associated with such disruptions. Using an accelerated model of a process also affords the opportunity to sample data in an accelerated manner. When a computer is used to model or simulate processes, the model can be crafted to mimic sophisticated processes having random or chaotic aspects. Of course, with the use of computers also comes great flexibility in providing visual and audio depictions of the modeled process and changes to the process. As applied to learning, the use of a simulation to support the lessons conveying instructional content is advantageous by providing an experience that engages and entertains the user while also supporting the instructional aspects of the lesson.

As applied to learning Six Sigma techniques, a suitable model or simulation should afford the user the opportunity to identify one or more critical to quality factors of a process. The model should also afford measurement of the process in terms of the critical to quality factors. The model should also afford the opportunity to vary or control aspects of the process and provide outputs that correspond to the changes made. In effect, for a model to be useful in the context of Six Sigma learning, teaching, and assessment, the model should afford the user the opportunity to use or practice the techniques associated with DMAIC approaches to process improvement. For a tool to be most useful as support for a lesson teaching a Six Sigma technique, the tool should also incorporate a model or simulation.

An exemplary tool according to the present invention is a simulation called SigmaBrew, which includes a predefined scenario, i.e., the operation of a coffee shop. SigmaBrew is created by Moresteam.com LLC in Lewis Center, Ohio. The tool is preferably constructed using content delivered to the user by way of a database environment. The use of a database to provide content objects to the user affords flexibility in delivering a variety of scenarios having different back-stories, levels of difficulty, or learning objectives. For example, scenarios can be generated from SigmaBrew data and relationships by providing a filter that adjusts the data in a database for a particular operation (e.g., multiplies the data by an amount to reflect a manufacturing operation). For example, the scenario can be configured to apply to a student's actual business. Different databases (e.g., having different content objects and/or animation objects) or data that is modified allows different scenarios to be provided to different users without modifying the visual “container.” By thus incorporating a database structure to provide the tool's content, the tool can be used to provide a learning by doing experience to the student for a variety of problem solving methodologies and scenarios, simply by dynamically providing selected sub-sets of content to the user, i.e., the database affords using and re-using subsets of content for selected purposes without having to re-write the entire instructional game structure.

In one embodiment, a user obtains a username and password that enables the user to access a website providing the SigmaBrew simulation.

Specifically, with respect to Six Sigma techniques, tools learned from instructional materials can be utilized to assess the operational data generated by the simulation. Applying those tools and making decisions accordingly in the SigmaBrew simulation affords the user the opportunity to observe the outcomes of decisions made using Six Sigma techniques. Therefore, the SigmaBrew simulation supports the teachings of the Six Sigma lessons that the user previously reviewed and learned.

Prior to and/or during the simulation, the user can engage in various activities that reflect proficiency in one or more of the learned lessons. In the case of a Six Sigma technique lesson, for example, the simulation should afford the user the ability to determine the voice of the customer, measure the output important to the customer, translate the output into internal specifications, determine a design or next step based on the internal specifications, implement the design during the simulation, and evaluate the design based on the on-going results (e.g., a score).

The system 100 of the tool of the present invention includes a plurality of modules that are adapted to be used by or run on either the client computer 105 or the server 110. The modules include the computer-based simulation which is operable to generate related data to be stored in the computer memory. In some embodiments, the modules also include one or more lessons including content of various forms for teaching one or more techniques. Preferably, the instructional content includes information relating the simulation in a manner supporting the teachings of the lessons, either as practice or illustration of the lessons or as an assessment of proficiency of skills conveyed by the lessons. The lesson modules may include information usable to obtain the simulation related data, analyzing the simulation related data and can include content directed to at least an aspect of the techniques using the analyzed data to teach the lesson.

In an exemplary embodiment of a computerized simulation used to exercise and evaluate a student's understanding of Lean Six Sigma concepts, the student, using a client computer 105, accesses a website hosting a computer application. In some embodiments, the student may be required to enter a username/password combination in order to gain access to the website. The application can include one or more introductory screens to acquaint the user with the simulation.

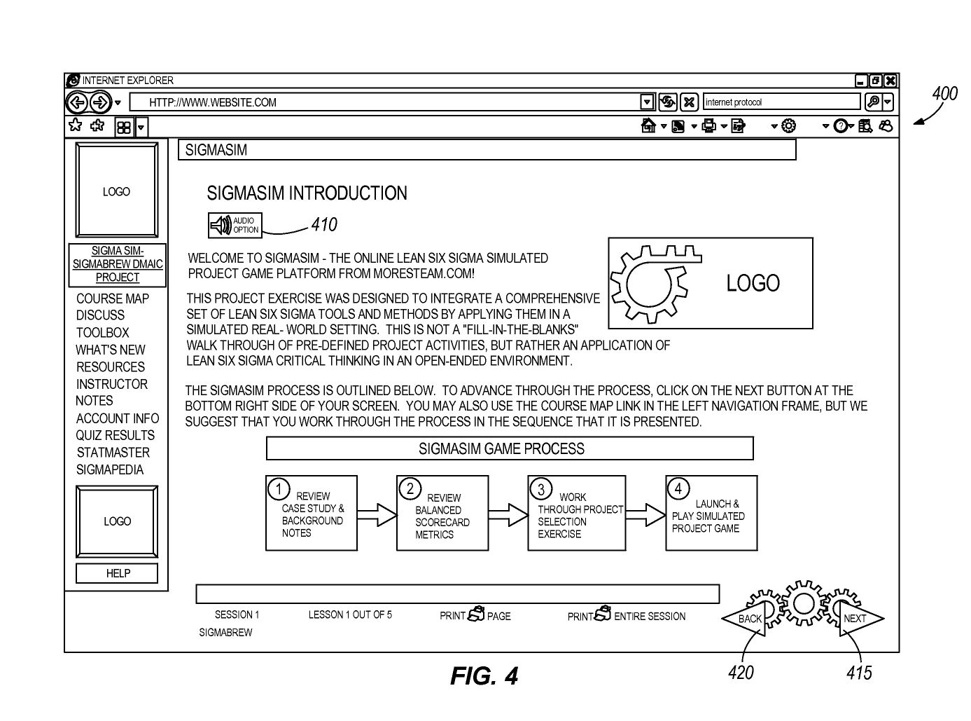

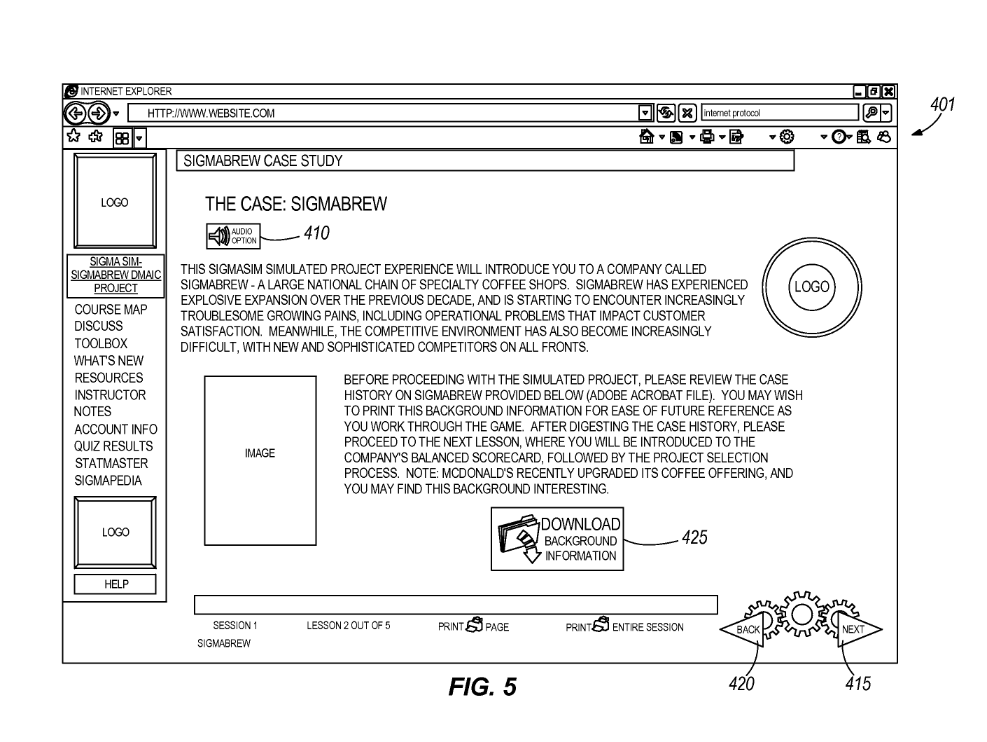

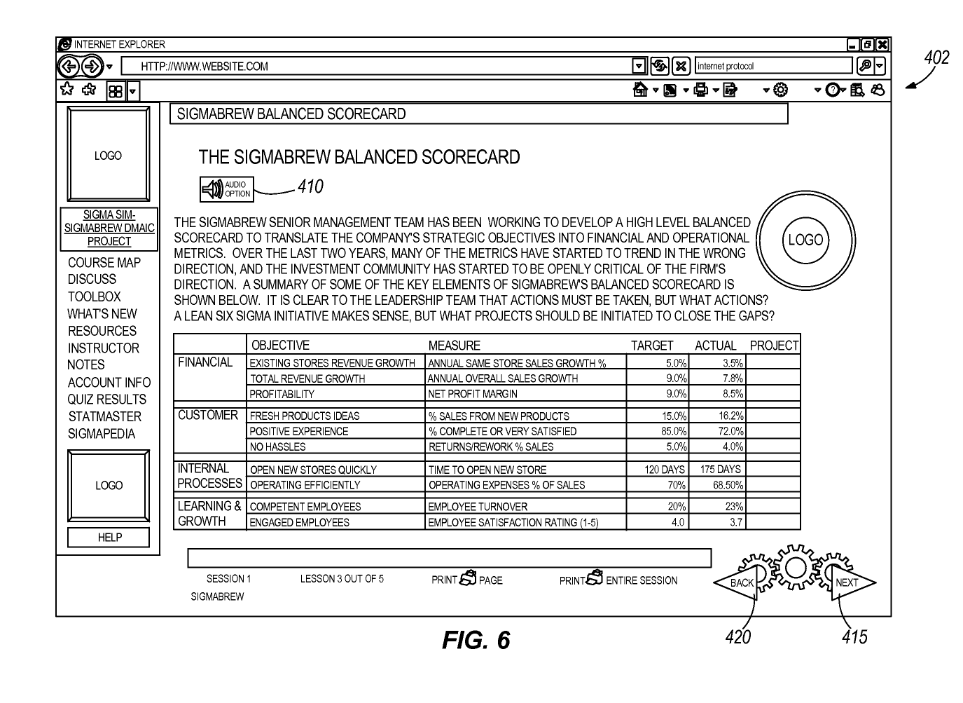

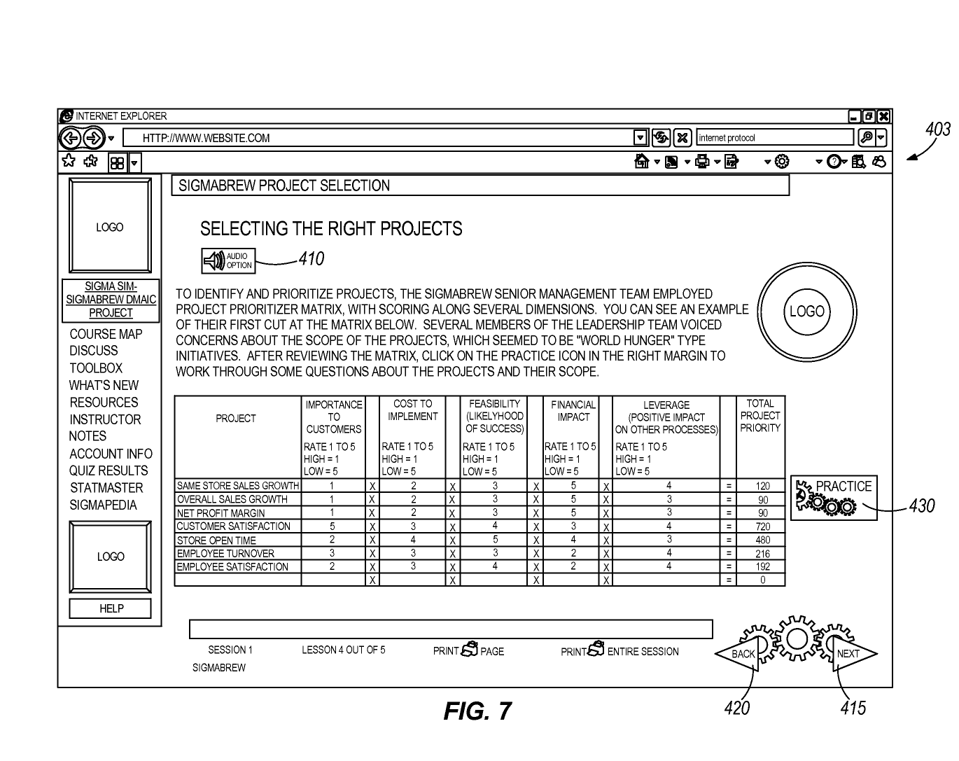

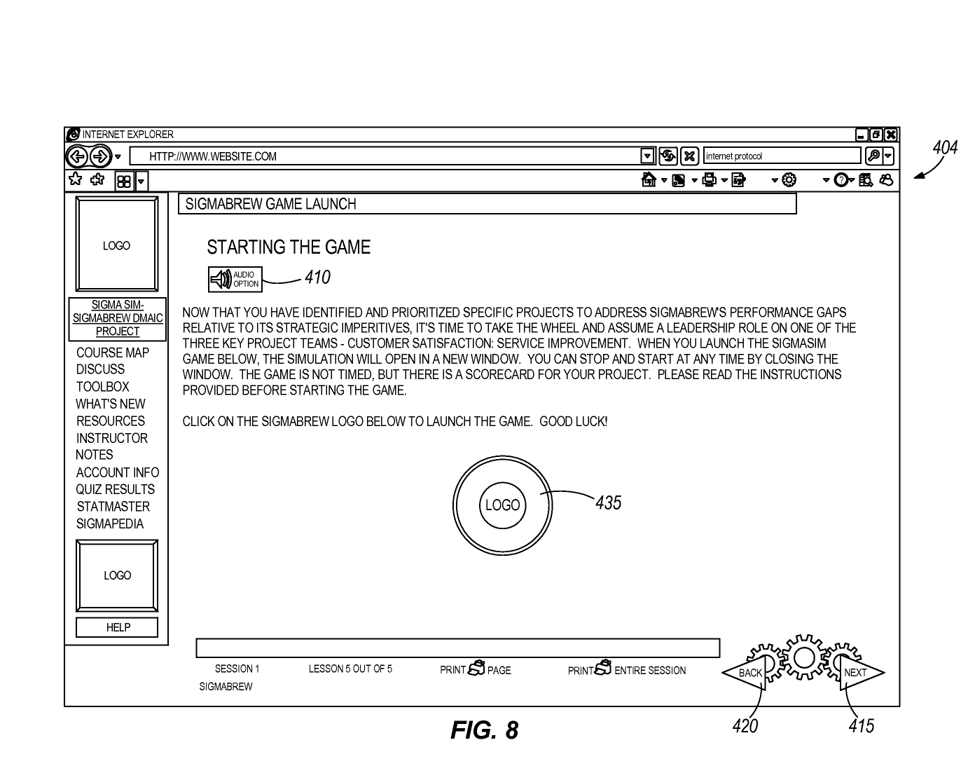

FIGS. 4-8 represent exemplary introductory screens 400-404. A first screen 400 (FIG. 4) provides an overview of the simulation. In some embodiments, one or more of the screens 400-404 include a button 410 to launch an audio file that provides the information on the screens 400-404 in an audio format. Navigation buttons, next 415 and back 420, enable the user to move to next or previous screen respectively. Clicking on the next button 415 accesses a second screen 401.

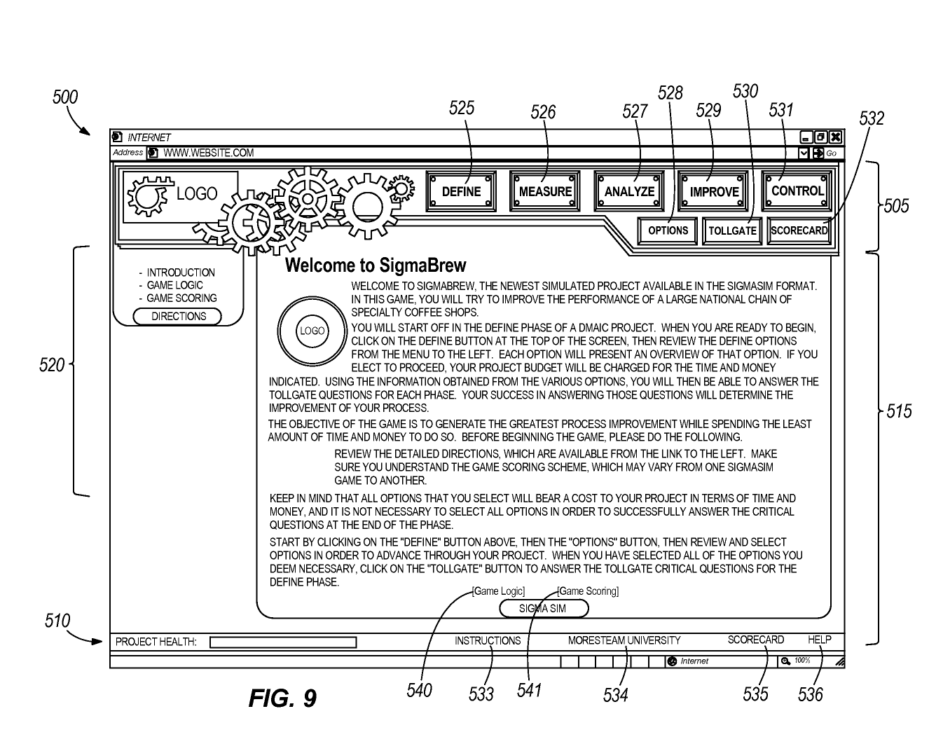

The second screen 401 provides a high level background regarding the simulation. The second screen 401 also provides a button 425 that provides a link to download a file (e.g., in Adobe®.pdf format) containing a more detailed description of the simulation (e.g., the SigmaBrew case history). A third screen 402 and fourth screen 403 provide more data relating to the scenario used in the simulation. The fourth screen 403 also provides a button 430 linking to practice questions (e.g., in a new window). The practice questions enable the student to work through defining a scope of a project reflected in the simulation/scenario by answering a series of multiple choice questions. Feedback is given to the student as to why the answer the student gave was right/wrong along with the correct answer including the reason the answer is correct. Finally, a fifth screen 404 is accessed providing a link 435 to the simulation. The link 435 opens the simulation in a new window 500 (FIG. 9).

FIG. 9 is an exemplary webpage 500 of an embodiment of the invention. The webpage 500 is constructed in four sections, a main navigation section 505, a secondary navigation section 510, a first content section 515, and a second content section 520. The webpage 500 includes a define button 525, a measure button 526, an analyze button 527, an improve button 529, a control button 531, an options button 528, a tollgate button 530, a first scorecard button 532, a second scorecard button 535, an instructions button 533, and a project health indicator 510. The first and second content sections 515 and 520 can, depending on the content being displayed, include hyperlinks (e.g., hyperlinks 340 and 341) to one or more web pages.

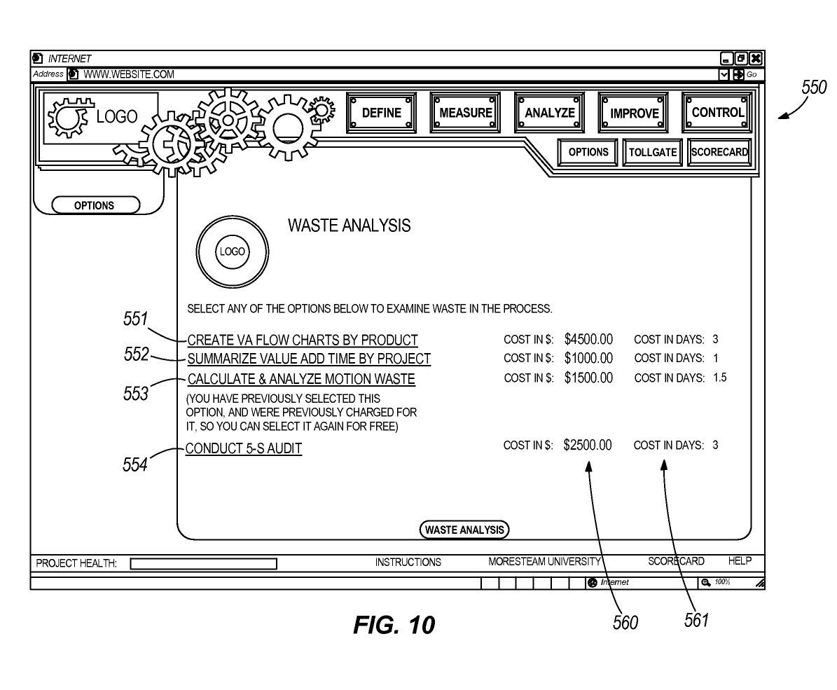

The define button 525, measure button 526, analyze button 527, improve button 529, and control button 531 access, as described below, web pages specific to their respective DMAIC phases. The options button 528 accesses a set of categories of tasks specific to the DMAIC phase being addressed (worked on) by the student. The categories are displayed in the second content section 520. Table 1 lists the categories included in each of the DMAIC phases according to an embodiment of the invention. Each category includes one or more tasks. The student selects a category from the second content section 520 and the tasks are displayed as hyperlinks in the first content section 515. FIG. 10 illustrates an exemplary task screen 550 for the Waste Analysis tasks 551-554 during the Analysis phase. Each task 551-554 has an associated dollar cost 560 and time cost 561. The student chooses which tasks to perform by clicking on its appropriate hyperlink. The student then receives the information from the task and is charged the costs for the task. As shown in FIG. 10, tasks that were previously selected by the student are available to the student at no additional cost.

TABLE 1

| DMAIC Phase | Task Category |
|---|---|
| Define | Conduct Customer Survey |
| | Research the Process |
| | Interview Customers |
| | Historical Company Information |
| | Historical Customer Data |
| | Collect External Information |
| | Conduct Meeting |
| | Develop Plans |
| Measure | Sales Mix & Defect Data |
| | Evaluate Measurement System |
| | Collect Work Flow Data |
| | Stratify Time by Product> |
| | Stratify Data by Time |
| | Other Data Dimensions> |
| | Demand and Queues |
| | Process Inputs |
| Analyze | Map Value Stream |
| | Waste Analysis |
| | Serving Time Variation |
| | Analyze Demand |
| | Analyze Flow |
| | Analyze Rework |
| | Analyze Product Mix vs. Service Time |
| | Analyze Staffing |
| Improve | Add Equipment |
| | Human Resources |
| | Product Actions |
| | Revise Order System |
| | Revise Process Steps |
| | Reporting & Communication |
| Control | Control Plan |
| | Document Work Practices |
| | Best Practices |
| | Confirm New Capability |
| | Project Handover & Audit |

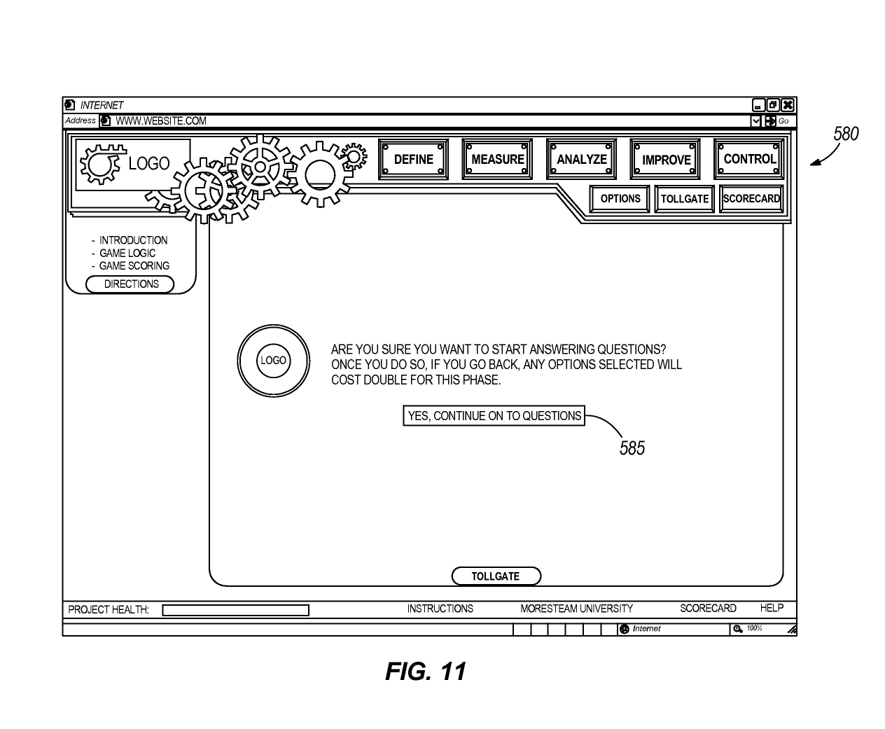

Once the student has all of the information (e.g., has completed all of the tasks) the student believes is necessary to answer the critical questions for the DMAIC phase the student is working on, the student selects the tollgate button 530. Selecting the tollgate button 530 displays a screen 580 of FIG. 11 which includes a hyperlink 585 to continue on to the critical questions. The student is expected to gather all the information necessary by completing tasks before entering the tollgate. If the student enters the tollgate and needs to return to the tasks in order to answer a critical question, the student is penalized. In some embodiments, the penalty is a doubling of the costs (time and money) charged to the student. However, as shown in FIG. 10, the student is able to access tasks which the student previously purchased for no additional cost or penalty.

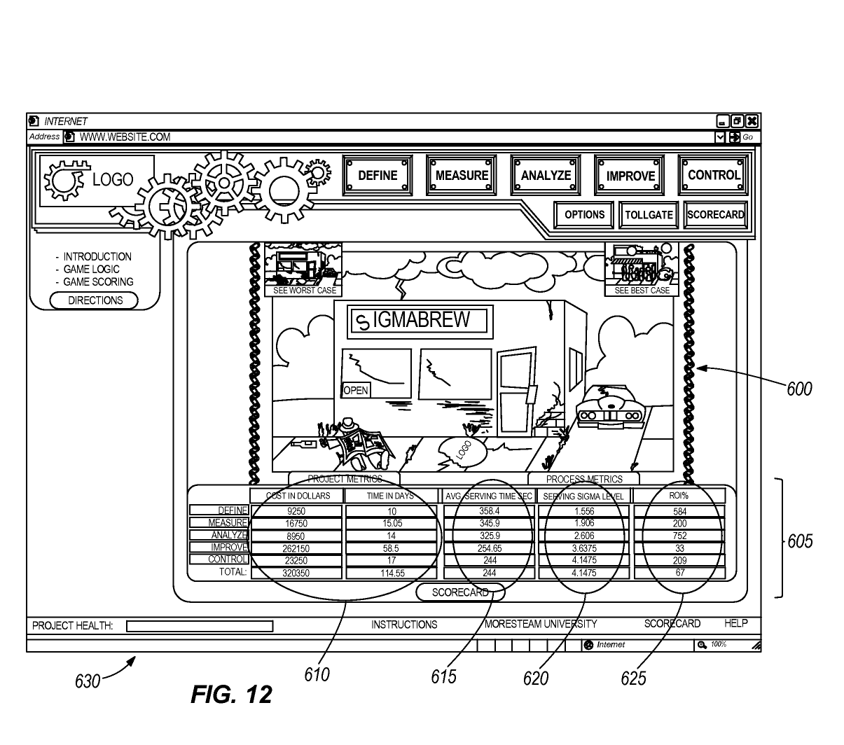

At any time, the student may select to view the scorecard by clicking either the first or second scorecard buttons 532 and 535. FIG. 12 illustrates a scorecard including a visual image indication of project health 600 and a grid 605 showing project metrics for each DMAIC phase as well as a total process metric. In the embodiment shown, process metrics include costs 610 (money and time), resultant serving time 615, sigma level 620, and return on investment 625. An indication of the overall project health 630 is displayed in the second navigation section 510 of each screen of the simulation.

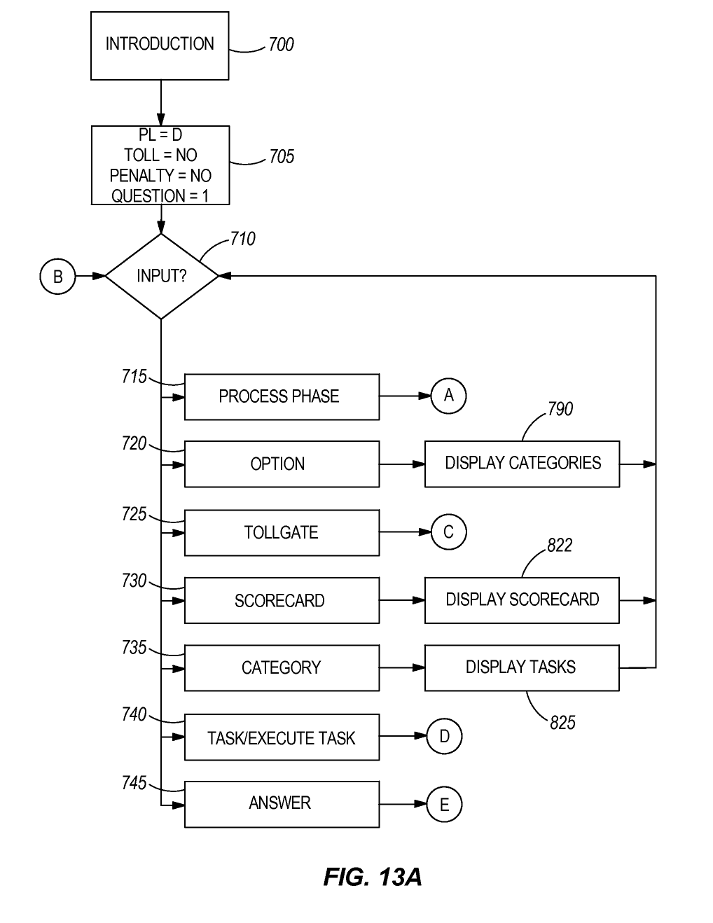

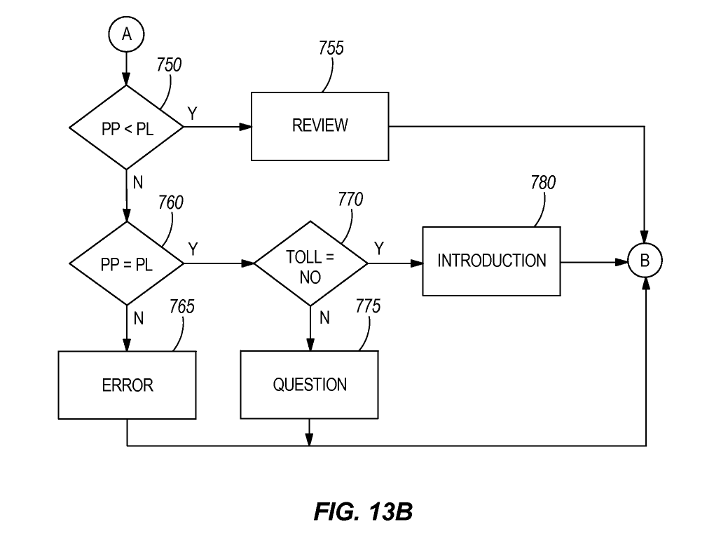

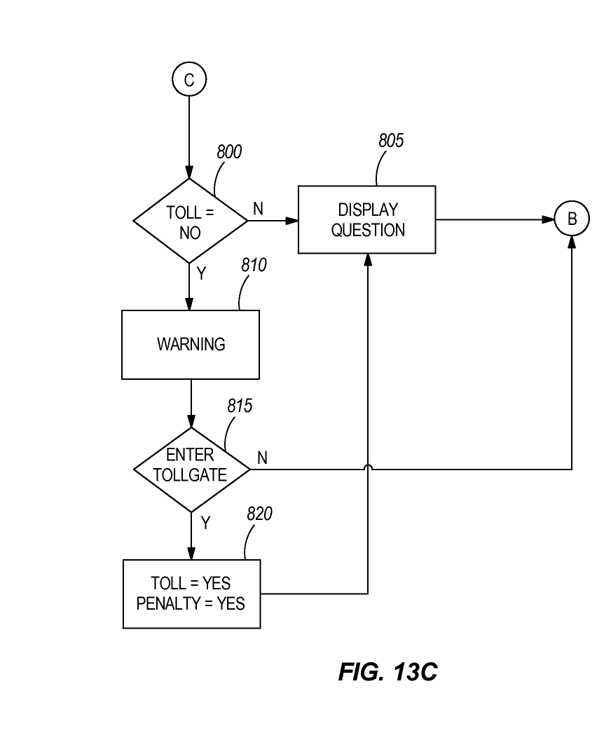

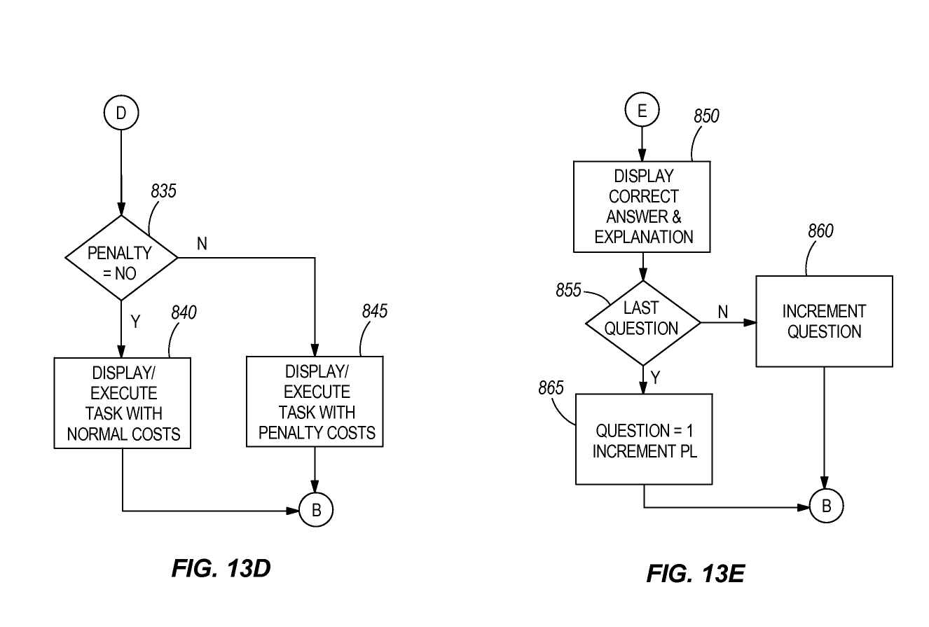

FIGS. 13A-13E are flow charts of an embodiment of a method of operation of a tool allowing a student to practice skills in and for determining a student's competency in the DMAIC road map for Six Sigma process improvement.

As discussed above (e.g., for FIGS. 4-8), the tool starts with an introduction (step 700) of the simulation. The introduction explains the simulation process and provides background information to enable the student to begin the DMAIC simulation process. Along with displaying information, the tool initializes several flags and parameters (step 705). A process level (PL) parameter tracks which process level the student is currently working on. The student steps through the process levels in order—Define (D), Measure (M), Analyze (A), Improve (I), and Control (C). As will be seen, once the student completes a process level, the student moves on to the next level, in order. The student can return to a previous process step for review, but cannot work on previous steps or alter the score for a completed level (e.g., redo a completed level). At step 705, a toll flag is set to “NO.” The toll flag indicates whether the student has entered a tollgate function for the present process level. A penalty flag is also set to “NO.” The penalty flag is used to determine if the student is subject to a penalty (e.g., additional costs) for executing a task. Generally, a student incurs a penalty for executing a task in a process step after the student has entered the tollgate function in that process step. As part of the tollgate function, the student is presented with a series of questions. At step 705 a question flag is set to “1” to indicate that the tollgate function should begin at the first question for the present process level. Next, the tool waits for an input from the student (step 710).

The student can select, depending on the information being displayed, eight types of inputs (additional inputs such as a “Help” button 536 are available but will not be discussed here). The types of inputs include selecting a process phase (step 715), selecting options (step 720), selecting the tollgate function (step 725), selecting the scorecard (step 730), selecting a category of tasks for a particular process step (step 735), selecting a task and selecting to execute a task (step 740), and answering a question as part of the tollgate evaluation function (step 745). The input types are not all available on every screen.

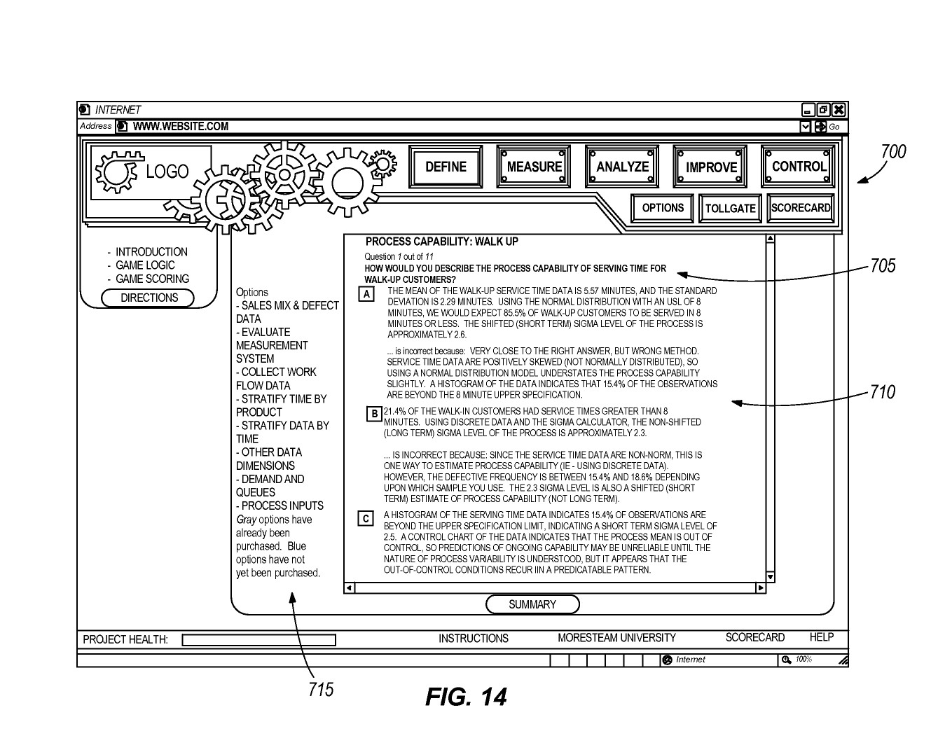

Following the selection of a process phase (PP) (e.g., the Define, Measure, Analyze, Improve, or Control phases) at step 715, the operation next determines whether the chosen PP is less than (i.e., comes before in the DMAIC sequence) the present process level (PL) (step 750, FIG. 13B). For example, if the student has completed the Define and Measure process phase, the PL is set to Analyze. If the student chooses either the Define or Measure phases, which are less than the PL, the tool provides a review screen to the student for the chosen PP (step 755). The review screen 700 (see FIG. 14) displays all of the critical questions 705 for the PP along with the correct answers and explanations 710. The review screen 700 also allows the student access to the categories of tasks for the chosen PP. Categories, for which the student has previously selected one or more of the tasks, are highlighted to indicate the selection.

If the PP was not less than the PL, the tool checks if the PP is equal to the PL (step 760). If the student attempts to access a PP that comes after the present PL (i.e., PL>PP) an error screen is displayed informing the student that this PP is not yet available (step 765). If the PP and PL are equal, the tool determines if the student has entered the evaluation phase (tollgate) of the PP (step 770). If the student is in the evaluation phase, a critical question (based on the question flag) is presented to the student (step 775). If the student has not entered the evaluation phase for the PP, an introductory screen for the PP is displayed (step 780).

Referring back to FIG. 13A, if the student selects the option input (step 720), a list of categories of tasks for the PL is displayed (with hyperlinks) in the second content section 520 of the display (step 790). As discussed above, categories, in which the student has selected one or more of the tasks, are highlighted to indicate the selection.

If the student selects the tollgate function (step 725), the tool checks if the student has previously entered the tollgate function (step 800, FIG. 13C). If the student has previously entered the tollgate function (tollgate=yes), the tool displays a question (step 805). If the student has not previously entered the tollgate function for the PL, a warning is displayed (step 810) explaining that the student will be penalized if the student executes tasks after entering the tollgate function, and asking if the student wants to continue to enter the tollgate function (step 815). If the student chooses to enter the tollgate function, the toll flag is set to yes, the penalty flag is set to yes (step 820), and the tool displays the first question (step 805).

If the student chooses the scorecard (step 730, FIG. 13), the tool displays the present scorecard reflecting the students progress and results in implementing the DMAIC process (step 822). If the student chooses one of the categories (step 735) (e.g., displayed in the second content section 520), the tool displays, in the first content section 515, the tasks for the chosen category (step 825) (see e.g., FIG. 10).

If the student chooses a task (or chooses to execute a task) (step 740) by clicking on the task (or execute button) in the first content section 515, the tool checks if the penalty flag is set to “no” (step 830, FIG. 13D). Based on the setting of the penalty flag, the tool displays information (including its costs) on the task (or executes the task with the student incurring the costs of the task) (step 840 or 845). Previously executed tasks are always available to the student for execution at no charge whether the penalty flag is set to yes or no.

Again, referring to FIG. 13A, if the student answers a question (step 745), as part of the tollgate function, the tool displays the question with the student's answer and the correct answer along with explanations of each (step 850, FIG. 13E). The tool then checks if the question answered is the last question for the PL (step 855). If there are more questions, the tool increments the question flag to the next question (step 860). If the question answered was the last question for the PL, the tool resets the question flag to one and increments the PL to the next level (e.g., to M from D and so on) (step 865).

In one embodiment, the tool allows multiple students, using a plurality of client computers 105, to work together on a single project simulation. In other embodiments, multiple teams, comprising one or more students and/or one or more client computers 105, execute a project simulation. A common scorecard displays the performance of each of the teams. In some embodiments, an instructor oversees the project simulation, controlling the progress of the student(s) or teams, providing feedback, and/or displaying a combined scorecard. For example, the instructor can stop the simulation at any time so the teams/students can exchange work product and understand decisions made by other players throughout the simulation. In addition, the instructor and/or students can critique one another, allowing the students to teach each other. By introducing aspects of collaboration and competition to the instruction, the tool enhances the learner's engagement in mastering the presented lessons and mastering the skills required to achieve the tools learning objectives.

Accordingly, the tool enables the student to step through the DMAIC process, exercising the student's skills and evaluating the student's progress along the way. The student is provided feedback as to how well the student has implemented the functions of the DMAIC process and how well the student understands the process.

Various features and advantages of the invention are set forth in the following claims.

What is claimed is:

1. A method of enhancing a student's knowledge of Six Sigma quality concepts, the method comprising:
establishing a scenario;
providing a plurality of phases in the scenario, the phases related to the Six Sigma quality concepts;
providing a plurality of tasks for each of the plurality of phases, the plurality of tasks based on the scenario and the plurality of phases;
assigning a cost to each of the plurality of tasks;
enabling the student to choose and execute one or more of the plurality of tasks for each phase;
charging the student the cost for each of the plurality of tasks executed;
providing the student with a plurality of questions, the questions formulated to test the student's understanding of the scenario, the student's understanding being enhanced by the executed tasks; and
scoring the student's answers to the plurality of questions and the costs charged.

2. The method of claim 1, further comprising adjusting the cost of each of the plurality of tasks executed to penalize the student when a task is executed following the providing the student with the plurality of questions.

3. The methods of claim 1, wherein the phases include a define phase, a measure phase, an analyze phase, an improve phase, and a control phase.

4. The method of claim 1, wherein the scenario provided is related to the student's business.

5. The method of claim 1, further comprising providing the student with the correct answers and explanations to the plurality of questions.

6. The method of claim 5, further comprising providing the student with an explanation of why an answer chosen by the student is correct or incorrect.

7. The method of claim 1, wherein the scoring is based on a projected number of defects per million opportunities.

8. The method of claim 1, wherein the method is executed on a computer.

9. The method of claim 8, wherein the student uses a client computer, the client computer accessing a remote computer, the remote computer providing the scenario, the plurality of phases, the plurality of tasks, and the plurality of questions.

10. A simulation tool for enhancing a user's comprehension of a Six Sigma lesson, the tool comprising:
a computer processor including a browser application;
a database accessible by the computer processor; and
a software program stored in a computer readable medium accessible by the computer processor, the software being operable to
present a webpage configured to be accessed by the browser application,
retrieve content from the database, and
deliver the content to the webpage, the content configured to evaluate the user's comprehension of the Six Sigma lesson.

11. The simulation tool of claim 10, further comprising a server containing the webpage and the database.

12. The simulation tool of claim 1 1, further comprising a network, the computer processor configured to communicate with the server via the network.

13. The simulation tool of claim 10, further comprising a scenario presented to the user via the webpage.

14. The simulation tool of claim 13, further comprising a plurality of tasks, each task providing information about the scenario and having an associated cost, the user choosing to execute one or more of the tasks and incurring the associated cost for each task executed.

15. The simulation tool of claim 14, further comprising a plurality of questions related to the scenario.

16. The simulation tool of claim 15, further comprising a scorecard, the scorecard providing an indication of the user's level of skill and knowledge based on the costs incurred by the user and answers to the questions chosen by the user.

17. A method of enhancing a user's knowledge of the Six Sigma DMAIC process, the method comprising:
displaying a plurality of phases to the user, the phases including a define phase, a measure phase, an analyze phase, an improve phase, and a control phase, the plurality of phases being provided in a predetermined order;
preventing a user from accessing one of the plurality of phases until a previous one of the plurality of phases has been completed;
displaying an introduction, a plurality of tasks, and an evaluation for each of the plurality of phases;
generating a review for each of the plurality of phases after a respective one of the plurality of phases is completed;
penalizing the user for executing one of the plurality of tasks for a respective one of the plurality of phases after the evaluation for the one of the plurality of phases has been started; and
generating an indication of expertise of the user based on the plurality of tasks executed and a result of the evaluations for each of the plurality of phases.

18. The method of claim 17, further comprising providing a plurality of questions to be answered by the user for each evaluation.

19. The method of claim 18, further comprising providing feedback to the user in the form of correct answers to the plurality of questions and explanations of the correct answers, and providing a scorecard to the student indicating the student's overall performance.
